(19) United States
(12) Patent Application Publication
(10) Pub. No.: US 2011/0073283 A1
(43) Pub. Date: Mar. 31, 2011

(54) HEAT DISSIPATION DEVICE

(75) Inventor: CHAO-JUI HUANG, Taipei Hsien (TW)

(73) Assignee: HON HAI PRECISION INDUSTRY CO., LTD., Taipei Hsien (TW)

(21) Appl. No.: 12/608,941

(22) Filed: Oct. 29, 2009

(30) Foreign Application Priority Data
Sep. 30, 2009 (CN) 200910308042.0

(51) Int. Cl. G06F 1/20; F28D 15/04; F28F 7/00

(52) U.S. Cl. 165/104.26; 165/185

(57) ABSTRACT

A heat dissipation device comprises a substrate, a fin assembly located above the substrate and at least one heat pipe connecting the substrate with the fin assembly together. The fin assembly comprises a plurality of fins stacked one above another along a bottom to top direction and space from each other with a gap defined between two neighboring fins. Each of the fins defines a plurality of ventilating holes therein. The ventilating holes of the fins are aligned with each other and form a plurality of vertical air channels in the fin assembly along the bottom to the top direction for ambient air in the gaps flowing therethrough upwardly to escape the fin assembly.

### BACKGROUND

1. Technical Field

The present disclosure relates to heat dissipation devices, and particularly to a heat dissipation device for use in an electronic device such as a computer.

2. Description of Related Art

With continuing development of electronic technology, heat-generating electronic components such as central processing units (CPUs) in enclosures of computers are generating more and more heat which requires immediate dissipation. Heat dissipation devices are commonly used to cool the CPUs.

A conventional heat dissipation device includes a substrate for contacting with a CPU installed in an enclosure of a computer, a plurality of fins extending upwardly from the substrate, and a cooling fan mounted on the fins. The fins are spaced from each other with an air passage defined between every two neighboring fins. The cooling fan provides cooling airflow through the air passages to accelerate heat convection between the fins and the ambient air. However, the cooling fan usually vibrates and makes noise during operation, which may irritate and distract users. Furthermore, the cooling fan occupies a large space of the enclosure, contrary to a desire for compactness in computers.

Therefore, an improved heat dissipation device is desired to overcome the above described shortcomings.

### BRIEF DESCRIPTION OF THE DRAWINGS

FIG. 1 is an exploded, isometric view of a heat dissipation device in accordance with an exemplary embodiment.

FIG. 2 is an assembled, isometric view of the heat dissipation device of FIG. 1.

FIG. 3 is a front view of the heat dissipation device of FIG. 2.

### DETAILED DESCRIPTION

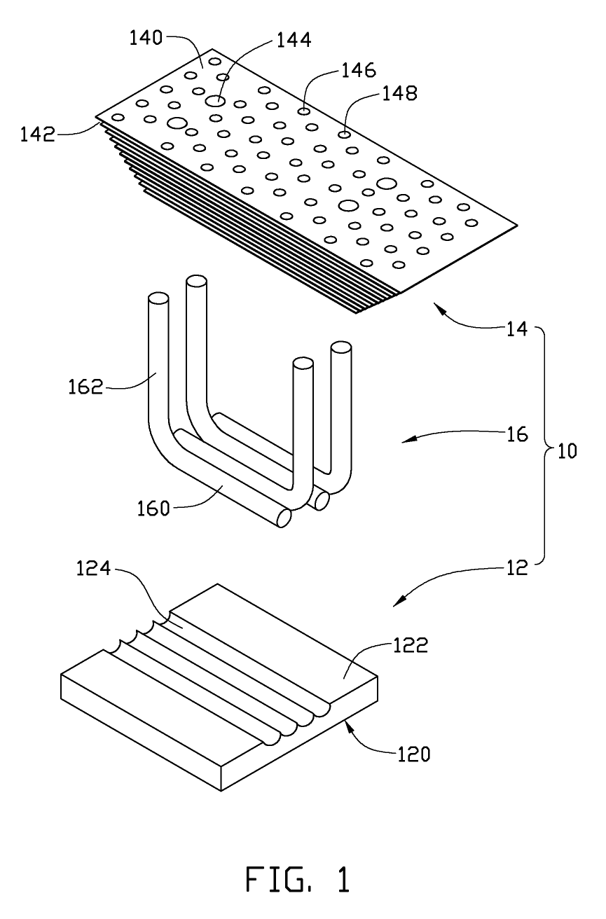

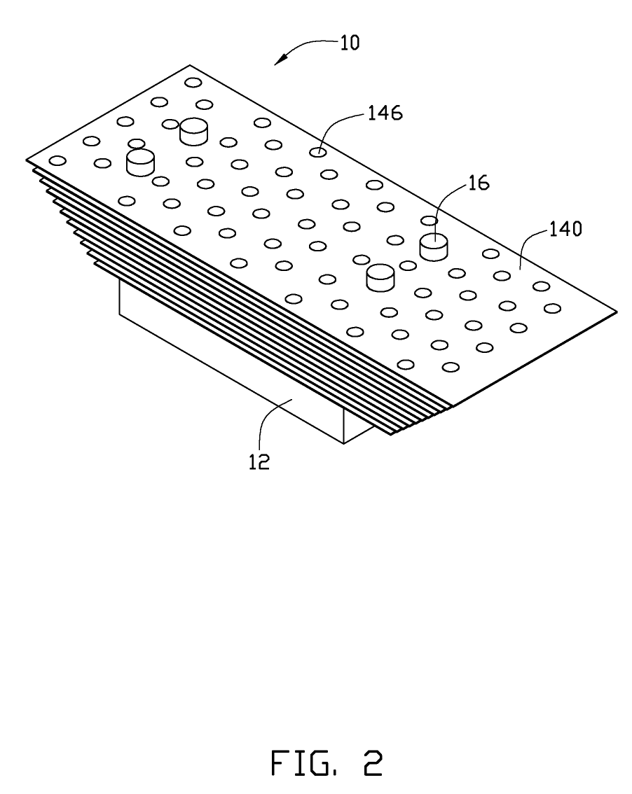

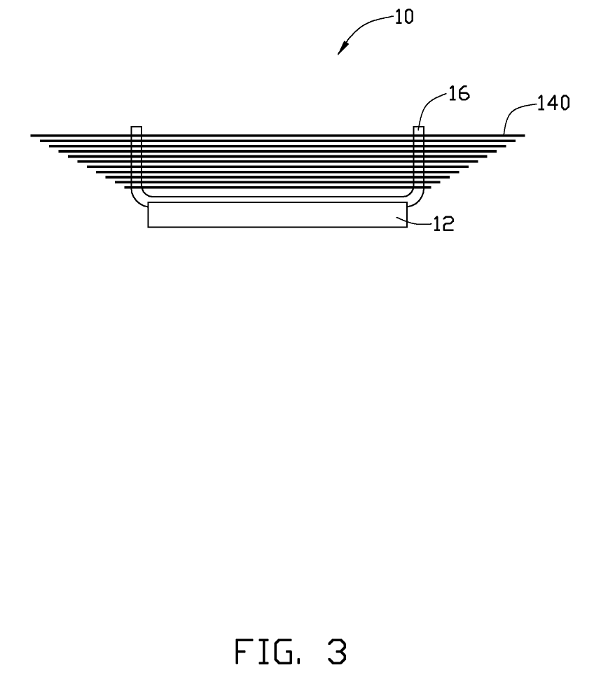

Referring to FIGS. 1-3, a heat dissipation device 10 in accordance with an exemplary embodiment of the present disclosure is shown. The heat dissipation device 10 includes a substrate 12 for receiving heat from heat-generating components (not shown), a fin assembly 14 located above the substrate 12, and four L-shaped heat pipes 16 connecting the fin assembly 14 with the substrate 12.

The substrate 12 is made of metal with high heat conductivity coefficient and has a rectangular shape. The substrate 12 includes a planar bottom surface 120 and an opposite top surface 122 facing the fin assembly 14. The substrate 12 defines four elongated parallel grooves 124 in the top surface 122 thereof. The grooves 124 extend from one edge to an opposite edge of the substrate 12. The grooves 124 each are semicircular in cross section. The heat pipes 16 each include an elongated evaporating section 160 and an elongated condensing section 162 substantially perpendicular to the evaporating section 160. The heat pipes 16 engage with the grooves 124 of the substrate 12 with the evaporating sections 160 respectively received in the grooves 124 of the substrate 12, while the condensing sections 162 are perpendicular to the substrate 12.

The fin assembly 14 includes a plurality of parallel fins 140 stacked one above another with a gap 142 defined between every two neighboring fins 140. Each of the fins 140 has a flat, rectangular shape. The fins 140 have the same width but different lengths. The lengths of the fins 140 of the fin assembly 14 decreases gradually along a direction from bottom to top, and centers of the fins 140 are aligned with each other, thereby the fin assembly 14 forms an inverted frustum profile. A size of the bottommost fin 140 is greater than that of the substrate 12.

Each of the fins 140 defines four through holes 144. The through holes 144 of each fin 140 are aligned with the holes of the other fins 140 to form four passages for extension of the four condensing sections 162 of the heat pipes 16 therethrough, respectively. Each of the fins 140 defines a large number of ventilating holes 146 therein. The ventilating holes 146 of each fin 140 are substantially evenly distributed, and a density of the ventilating holes 146 of each fin 140 is the same as that of the other fins. Since the size of the fins 140 increases from bottom to top, a number of the ventilating holes 146 of the fins increases from bottom to top. Each of the ventilating holes 146 of each of the fins 140 is aligned with corresponding ventilating holes 146 of the other fins 140 to form a vertical air channel 148 in the fin assembly 14. An extension direction of the air channels 148 is perpendicular to the substrate 12. The air channels 148 communicate air below the fin assembly 14 with the air above the fin assembly 14. Depth of the air channels 148 located at a center portion of the fin assembly 14 which is on the bottommost fin 140 are the same, and depth of other air channels 148 at lateral sides of the bottommost fin 140 decreases outwardly and gradually from the center portion to lateral sides of the topmost fin 140 since the size of the fins 140 decreases gradually from top to bottom.

In assembly, the evaporating sections 160 of the heat pipes 16 are received and welded in the grooves 124 of the substrate 12, respectively, with the condensing sections 162 of the heat pipes 16 alternately located at two opposite sides of the substrate 12. The fin assembly 14 is located above the substrate 12 with the fins 140 parallel with the substrate 12. The bottommost fin 140 of the fin assembly 14 is spaced from the substrate 12 by a distance. The condensing sections 162 of the heat pipes 16 extend through the through holes 144 of the fins 140 from bottom to top, to thereby connect the substrate 12 and the fin assembly 14 together.

In operation, a minority of the heat generated by the heat-generating component is transferred to the substrate and then dissipated to outside directly by the substrate, while a majority of the heat is transferred to the evaporating sections 160 of the heat pipes 16, then to each fin 140 of the fin assembly 14 via the condensing sections 162 of the heat pipes 16. Finally the heat is dissipated to outside between the fins 140. Accordingly, the air between the fins 140 of the fin assembly 14 is heated and has a tendency to flow upwardly. Since the air channels 148 of the present heat dissipation device extend through the fin assembly 14 from bottom to top and thus communicate air below the fin assembly 14 with the air above the fin assembly 14, the heated air flows upwardly via the air channels 148 and finally escapes to outside. Further, since the bottommost fin 140 of the fin assembly 14 is spaced from the substrate 12 a distance, a space is defined between the fin assembly 14 and the substrate 12 for cooling air from outside to enter and pass through the air channels 148 enhancing heat exchange. Moreover, the sizes of the fins 140 of the fin assembly 14 increase from bottom to top, a few air channels 148 are at lateral sides of the bottommost fin 14, thus airflow easily enters the air channels 148, which can further enhance the heat exchange between the fin assembly 14 and the ambient air.

As described above, since the present heat dissipation device has a large number of air channels 148 defined therein for heat exchange, a heat dissipation capability of the present heat dissipation device is relatively greater. Thus a cooling fan of conventional heat dissipation device can be omitted. Accordingly, noise of the cooling fan is avoided, and a space occupied by the present heat dissipation device 10 without cooling fan is small.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat dissipation device, comprising:
a fin assembly comprising a plurality of fins stacked one above another along a bottom to top direction and space from each other with a gap defined between two neighboring fins, each of the fins defining a plurality of ventilating holes therein, the ventilating holes of the fins aligned with each other and forming a plurality of vertical air channels in the fin assembly along the bottom to the top direction for ambient air in the gaps flowing therethrough upwardly to escape the fin assembly.

2. The heat dissipation device of claim 1, wherein sizes of the fins decrease gradually from a top to bottom direction.

3. The heat dissipation device of claim 2, wherein the fin assembly has an inverted frustum profile.

4. The heat dissipation device of claim 2, wherein the fins of the fin assembly have the same width but different lengths.

5. The heat dissipation device of claim 3, wherein the air channels of the fin assembly are perpendicular to the fins.

6. A heat dissipation device, comprising:
a substrate;
a fin assembly located above the substrate, the fin assembly comprising a plurality of fins stacked one above another along a bottom to top direction and space from each other with a gap defined between two neighboring fins, each of the fins defining a plurality of ventilating holes therein, the ventilating holes of the fins aligned with each other and forming a plurality of vertical air channels in the fin assembly along the bottom to the top direction for ambient air in the gaps flowing therethrough upwardly to escape the fin assembly; and
at least one heat pipe connecting the substrate and the fin assembly together.

7. The heat dissipation device of claim 6, wherein sizes of the fins decrease gradually from a top to bottom direction.

8. The heat dissipation device of claim 7, wherein the fin assembly has an inverted frustum profile.

9. The heat dissipation device of claim 7, wherein the fins of the fin assembly have the same width but different lengths.

10. The heat dissipation device of claim 7, wherein a size of a bottommost fin of the fin assembly is greater than that of the substrate.

11. The heat dissipation device of claim 6, wherein the air channels of the fin assembly are perpendicular to the fins.

12. The heat dissipation device of claim 7, wherein lengths of the air channels around a bottommost fin of the fin assembly decreases outwardly, and are smaller than lengths of the air channels through the bottommost fin.

13. The heat dissipation device of claim 7, wherein a bottommost fin of the fin assembly spaces from the substrate a distance.

14. The heat dissipation device of claim 6, wherein each of the at least one heat pipe comprises an evaporating section and an elongated condensing section substantially perpendicular to the evaporating section, the evaporating section is fixed to the substrate while the condensing section is connected to and extends through the fin assembly.
